(19) United States
(12) Patent Application Publication
(10) Pub. No.: US 2014/0311336 A1
(43) Pub. Date: Oct. 23, 2014

(54) Microhydraulic System, in particular for use in Planar Microfluidic Laboratories

(71) Applicant: Robert Bosch GmbH, Stuttgart (DE)

(72) Inventor: Sebastian Berning, Frankfurt (DE)

(73) Assignee: Robert Bosch GmbH, Stuttgart (DE)

(21) Appl. No.: 14/249,005

(22) Filed: Apr. 9, 2014

(30) Foreign Application Priority Data
Apr. 22, 2013 (DE) 10 2013 207 193.0

(51) Int. Cl. F16J 3/02

(52) U.S. Cl. CPC F16J 3/02
USPC 92/96

(57) ABSTRACT

A microhydraulic system includes a first hydraulically acting element as a master element with a master diaphragm, and a second hydraulically acting element as an actuator element with an actuator diaphragm. The master diaphragm is coupled fluidically to the actuator diaphragm such that deflection of the master diaphragm causes deflection of the actuator diaphragm and actuation of the master diaphragm, both via a compressive force and via a tensile force being provided. The master diaphragm, as a function of deflection of the master diaphragm, thus exerts a compressive or tensile force upon the actuator diaphragm.

This application claims priority under 35 U.S.C. §119 to patent application no. DE 10 2013 207 193.0, filed on Apr. 22, 2013 in Germany, the disclosure of which is incorporated herein by reference in its entirety.

### BACKGROUND

The chemical and biological analysis of material samples often requires the handling of very small quantities of liquids. Examples of this are found, inter alia, in the case of samples in medicine (blood, saliva, urine, etc.) and in environmental analysis. The handling of these liquids is frequently still done manually today, taking up a large amount of time, in that the liquids are processed in succession according a fixed protocol.

Lab-on-a-chip systems (also designated as a pocket laboratory or chip laboratory, LoC in brief) accommodate the entire functionality of a macroscopic laboratory on a plastic substrate of only the size of a plastic card. Lab-on-a-chip systems are typically composed of two main components. A cartridge for once-only use (the actual LoC) which is in contact with the processed liquids and implements the basic operations, such as, for example, measuring, mixing, filtering, etc. For this purpose, as a rule, there are passive components, such as ducts and storage chambers for the reagents required and also active components, such as valves and pumps. The second main component is an analyzer which receives the above-described cartridge, controls the active components thereon according to a fixed program and subsequently reads out the result of the analysis and prepares it for the user. Such a system enables biochemical process sequences to be implemented in a fully automated way.

In LoC systems of planar construction, which are often used, pumping chambers or valves are formed on the cartridge as a result of the plastic deformation of a flexible diaphragm which is in contact with the enclosed liquids. The force for deforming this diaphragm is in this case usually provided pneumatically, that is to say at the introduction of a gas having a differential overpressure or underpressure with respect to a liquid on the other side of the diaphragm. The pneumatic control lines are contacted to the cartridge at defined points by the analyzer and are led in ducts in the control layer of the cartridge of the valves and pumping chambers.

DE 19949912 A1 shows a force step-up device in which a small stroke is to be stepped up to a large stroke with great force. For this purpose, a liquid is enclosed in the control layer above the diaphragm.

### SUMMARY

The microhydraulic system, in particular for use in planar microfluidic laboratories, has the advantage that, in contrast to conventional systems in which the time profile of the pressure which prevails on the diaphragm of a valve or of a pump can be influenced to only a limited extent in the case of pneumatic actuation, since, as a rule, switching can take place only between constant pressure levels, in this case, by means of the present disclosure, the actuation of the master element can, in principle, take place continuously or transmission of this actuation from the actuator element to components connected to the latter takes place continuously in turn. Furthermore, by means of the present microhydraulic system, it is possible to have a virtually loss-free transmission of pressures within the LoC system from a location of generation in the master element to the actuator element, in particular a pump or valve. In addition, the present microhydraulic system affords the advantage, as compared with conventional systems, that in this case force transmission from the master element to the actuator element is possible for transmitting both tensile forces and compressive forces, with the result that the actuator element, depending on its actuation, can either suck in or dispense fluid on the outlet side. As a result, in principle, the actuator element can be configured as a pump or as a valve, depending on the intended use provided for it, with the result that the possibilities for the use of the microhydraulic system are broadened substantially.

The above-described constant pressure levels present problems particularly when pumping chambers are being emptied or filled. If the diaphragm is lifted too quickly, the liquid in the pumping chamber cannot fill the volume immediately because of the flow resistance in the influx, and underpressure arises in the pumping chamber. Particularly at temperatures near the boiling point of the liquid, increased evaporation then occurs. The steam arising is then trapped as a bubble or foam in the pumping chamber and obstructs chemical or biochemical reactions there. This is the case, for example, in the polymerase chain reaction (PCR), an important process in molecular biology. There, in at least one process step (denaturation), the temperature is near the boiling point of the liquid (approximately 95° C.). A possible remedy for this is at the present time only a (permanently set) external throttling of the air stream, because of this, flexibility in adapting the actuation of the master element is lost, since any pneumatic connection of the control apparatus is linked to a fixed characteristic of the pressure profile. In contrast to this, by means of the present microhydraulic system, flexible damping of the time profile of the pressure on the diaphragm of the actuator element can be implemented directly on the LoC.

The present microhydraulic system advantageously ensures stabilization and homogenization of temperature-critical processes in pumping chambers. Since, in conventional LoC systems, the process air in the pneumatics is not thermally controlled, there are in temperature-critical processes, that is to say in processes which have to take place at defined temperatures, particularly in pumping chambers, brief temperature fluctuations in the vicinity of the diaphragm when process air in the control layer is admitted or discharged. In this case, because of the high surface-to-volume ratio, inhomogeneous temperature distributions are to be expected, which, for example in PCR, may lead to the formation of undesirable secondary products. The present microhydraulic system advantageously decouples the temperature-sensitive process side (here, the actuator element as a link to subsequent process components) from the actuation side (here, the master element), so that the abovementioned disadvantages in the actuation of the master element by means of compressed air are avoided.

Furthermore, the present microhydraulic system leads to sealing of the fluidic processes with respect to the environment or to the analyzer. In a conventional LoC system, the material of the diaphragm of an active element, particularly with a small thickness, is often permeable to process liquids, vapors and the compressed air in a pneumatic system. If, in addition, a vacuum is also applied above the diaphragm, materials are lost from the fluidic system. This leads, on the one hand, to a contamination of the pneumatic system and, on the other hand, to a modification of the process, since the composition of the liquids in the system changes over time. In contrast to this, in the present microhydraulic system, the fluid between the master element and the actuator element is separated from the respective adjacent functional interfaces, especially when the fluid is selected from a chemical point of view such that the processed materials in the fluidic system are not dissolved therein, and it thus forms an effective barrier to the environment or to the analyzer. In addition to this, in the present microhydraulic system, the fluid between the master element and the actuator element is separated from the environment or the analyzer and is closed off on itself, so that high process reliability in the use of the fluid is ensured. In the present context, a “fluid” designates especially preferably a liquid which is used for coupling the master element to the actuator element and, more specifically, a hydraulic liquid.

Whereas, in conventional LoC systems, direct mechanical control of the respective pumps and/or valves by the analyzer, for example by means of a tappet, substantially restricts flexibility in the configuration of the cartridge, since the position of the active components on the cartridge cannot in this case be varied, but instead is fixed essentially by the arrangement of the drives in the analyzer, the present microhydraulic system makes possible the flexible use of, for example, direct electric drives, with the result that the analyzer can advantageously be simplified in technical terms and the pressure profile of each active component on the cartridge becomes individually programmable. Thus, for example, a predetermined position for arranging an (electric) drive can be provided for all cartridges, in which case the master element shall then be arranged in the vicinity of the drive. However, in contrast to conventional systems, in the present microhydraulic system the position of the actuator element can in this case be selected very freely within the LoC, since an operative connection between the master element and actuator element is provided with the aid of their fluidic coupling and, consequently, structural separation between the master element and the actuator element occurs, thus, in turn, allowing a flexible arrangement of the actuator element in the LoC. In the present microhydraulic system, the fluid used may be, for example, water, silicone oils or perfluorocarbons, which act as a hydraulic liquid upon the master element or the actuator element. Preferred operating pressures for the master element or for the actuator element are in a range of 100 mbar to 10 bar.

The present microhydraulic system is preferably integrated into a (planar) microfluidic laboratory which preferably has a layered construction in the context of a layer system, in particular as a polymer layer system. The master element and the actuator element can be formed in a solid polymer substrate composed, for example, of PC, PEEK (polyetheretherketone), COP or COC. The thickness of the respective polymer substrates may amount to between 1 mm and 5 mm. Furthermore, the master element and the actuator element can have a flexible film for the master diaphragm or actuator diaphragm, and this film is formed, for example, from an elastomer, a thermoplastic elastomer, a silicone or a silicone rubber. The thickness of such a film may amount to between 50 μm and 2 mm. The dimension of a present microhydraulic system may amount, in a top view, to approximately 100 mm to 150 mm in each case for the width and the length.

Advantageous refinements of the disclosure may be gathered from the claims.

According to one refinement of the microhydraulic system according to the disclosure, the master element has a master chamber, and the actuator element has an actuator chamber which is different from the master chamber, and the master chamber is coupled to the actuator chamber by means of a fluidic flow duct. The present microhydraulic system is characterized by two chambers, one being designed as the master chamber and the other as the actuator chamber. Each of the chambers is divided in each case into two half chambers by means of a flexible diaphragm. A fluidic flow duct is formed in each case between one of the half chambers of the master chamber and of the actuator chamber. Preferably, in this case, the fluidic flow duct and also the master chamber and actuator chamber are filled, bubble-free, with a fluid, preferably in the manner of a liquid, for example hydraulic liquid. The purpose of the present microhydraulic system is to transmit a pressure, which acts upon the master diaphragm in the master chamber, to the actuator diaphragm via the fluidic flow duct. The actuator diaphragm, in turn, has in this case the task of transmitting the pressure of the fluid to the second half chamber of the actuator element, which second half chamber is coupled fluidically on the outlet side of the actuator element to pumping chambers and valves on the planar microfluidic laboratory, and thus implementing the actuation of these.

According to a further refinement of the microhydraulic system according to the disclosure, the master diaphragm and the actuator diaphragm are arranged essentially in one plane, a fluid-filled half chamber of the master chamber being arranged with respect to the master diaphragm on an opposite side of a fluid-filled half chamber of the actuator chamber. Depending on the thickness of the layers used in the layer system, the master chamber and the actuator chamber may be arranged in a single common layer or in two layers separated from one another. The plane may in this case preferably extend normally to the thickness direction of the microhydraulic system or normally to the transverse direction of the microhydraulic system.

According to a further refinement of the microhydraulic system according to the disclosure, the master diaphragm and the actuator diaphragm are arranged essentially in one plane, a fluid-filled half chamber of the master chamber and a fluid-filled half chamber of the actuator chamber being arranged on the same side with respect to the master diaphragm. Depending on the thickness of the layers used in the layer system, the master chamber and the actuator chamber may again be arranged in a single common layer or in two layers separated from one another. The plane may in this case preferably extend normally to the thickness direction of the microhydraulic system or normally to the transverse direction of the microhydraulic system. The arrangement of the master chamber and the actuator chamber with respect to the master diaphragm is governed by the application of the microfluidic laboratory and by the available space for the layout of the microhydraulic system within the dimensions of the microfluidic laboratory.

According to a further refinement of the microhydraulic system according to the disclosure, the master diaphragm and the actuator diaphragm are arranged in each case in different planes. The plane for the master diaphragm or for the actuator diaphragm may again preferably extend normally to the thickness direction of the microhydraulic system or normally to the transverse direction of the microhydraulic system.

According to a further refinement of the microhydraulic system according to the disclosure, one of the master element or the actuator element has a master chamber or an actuator chamber, the master diaphragm or the actuator diaphragm being in each case coupled directly by means of a fluidic flow duct to the actuator chamber or to the master chamber. Thus, the master diaphragm is then coupled to the actuator chamber by means of the fluidic flow duct or the master chamber is then coupled to the actuator diaphragm by means of the fluidic flow duct. In these configurations, the fluidic flow duct issues directly at the respective diaphragm of that element (master element or actuator element) which has no associated chamber.

According to a further refinement of the microhydraulic system according to the disclosure, the master diaphragm is coupled to an actuation element. Thus, the actuation element can be coupled to the master diaphragm, for example, by means of a clamping connection. In addition to this, a materially integral connection of the actuation element to the master diaphragm is also possible, for example by means of welding or adhesive bonding. In an equivalent alternative, the actuation element may be coupled to the master diaphragm positively and/or nonpositively. The actuation element in this case acts upon the master diaphragm, with the result that the master element exerts pressure or vacuum or suction upon the fluid in the master chamber as a function of the direction of action of the actuation element. In one embodiment, the actuation element may be a pneumatically acting air volume, while, in a further embodiment, the actuation element is a mechanical element which is coupled to the master diaphragm.

According to a further refinement of the microhydraulic system according to the disclosure, the actuation element is coupled to the master diaphragm in such a way that the actuation element, as a function of its direction of action, exerts a compressive or tensile force upon the master diaphragm. In this case, coupling between the master diaphragm and the actuation element is designed in such a way that a force is always introduced into the master diaphragm by the actuation element independently of the actual direction of action of the actuation element, as a result of which, in turn, an actuation of the master element which corresponds to the force takes place. This coupling advantageously allows actuation of the master element not only in a single direction of action of the actuation element, but in at least two directions of action, with the result that the possibilities for the use of the master element or of the entire present microhydraulic system are increased.

According to a further refinement of the microhydraulic system according to the disclosure, the actuation element is coupled magnetically to the master diaphragm. For this purpose, a magnetic metal must be connected to the diaphragm which, during operation, cooperates with a metallic portion of the actuation element for actuating the master diaphragm.

According to a further refinement of the microhydraulic system according to the disclosure, the actuation element has a lever portion which, for actuating the master element, cooperates with an actuation means. One example of an actuation means is a mechanical drive which can be implemented, in particular, by electric drives, such as, for example, electric motors (in conjunction with a threaded rod or with an eccentric in order to convert the rotational movement of the electric motor into a linear movement), piezoelectric actuators, electrostatic actuators or electromagnetic actuating drives (for example, moving-coil drives). Since, in these electric drives, the generation in time of the mechanical force upon the master diaphragm can be controlled in a simple way, it is thereby also possible to operate each master element with an individual pressure or tension or with an individual pressure or tension profile curve by means of an electronic control. By the analyzer being programmed, the actuating behavior can be adapted freely to the requirements of the analysis application which is implemented on a specific cartridge. Furthermore, the actuation element may additionally be coupled to a joint (element) and may thus, during operation, be pivoted about a pivot axis of the joint (element) in a predetermined angular range.

According to a further refinement of the microhydraulic system according to the disclosure, at least one of the master diaphragm and the actuator diaphragm is impermeable to the fluid. Preferably, both the master diaphragm and the actuator diaphragm are impermeable to the fluid between the two diaphragms, in particular to a hydraulic liquid, and therefore completely enclose the fluid. The fluid consequently cannot escape from the LoC.

According to a further refinement of the microhydraulic system according to the disclosure, the freezing point and the boiling point of the fluid are selected such that the fluid is in each case liquid over the entire temperature range which occurs at the actuator diaphragm during operation. This advantageously ensures that the fluid in each case completely fills the volume of the fluidic duct between the master diaphragm and the actuator diaphragm and ingress from the duct into the hydraulic system due to evaporation and the accompanying change in volume of the fluid is prevented.

According to a further refinement of the microhydraulic system according to the disclosure, the temperature of the fluid during operation is essentially identical to a temperature of a second fluid which is coupled to the actuator diaphragm on the outlet side of the actuator element. In order to stabilize thermally temperature-sensitive processes by means of a second fluid in a fluidic structure lying opposite the actuator chamber, the (first) fluid can be brought to the same temperature as the second fluid. Thus, in spite of the generally insufficient thermal insulation of the actuator diaphragm, no thermal fluctuations arise in the second fluid and the fluid is introduced into or discharged from the actuator chamber.

According to a further refinement of the microhydraulic system according to the disclosure, the flow resistance in the fluidic flow duct can be varied by means of the length and/or diameter of the fluidic flow duct. In principle, the flow resistance between the chambers of the master element and actuator element can be varied by a suitable choice of viscosity of the fluid and of the length and diameter of the fluidic duct. As a result, a rapid pressure rise on the side lying opposite the master chamber, such as occurs, for example, when compressed air is used for actuating the master element, can be damped, as required, during transmission to the actuator diaphragm. The dimensions of the fluidic duct which are necessary for this purpose are markedly larger on account of the higher viscosity of the fluid, as compared with gases, and can thus, in process terms, be manufactured more simply and with lower tolerances. External components for throttling the pressure rise in the pneumatics are therefore no longer necessary.

### BRIEF DESCRIPTION OF THE DRAWINGS

Exemplary embodiments of the disclosure are illustrated in the figures of the drawings and are explained in more detail in the following description.

In the drawings:

FIGS. 1A-1C show in each case diagrammatically a side view of a microhydraulic system according to a first to a third exemplary embodiment of the present disclosure;

FIG. 2 shows a side view of the microhydraulic system according to the first exemplary embodiment of FIG. 1A of the present disclosure, in which the master diaphragm is acted upon by a pressure;

FIG. 3 shows a side view of the microhydraulic system according to the first exemplary embodiment of FIG. 1A of the present disclosure, in which the master diaphragm is acted upon by a vacuum;

FIG. 4 shows a side view of the microhydraulic system according to the first exemplary embodiment of FIG. 1A of the present disclosure, in which thermal harmonization between two fluids separated from one another takes place;

FIG. 5 shows diagrammatically a side view of a microhydraulic system according to a fourth exemplary embodiment of the present disclosure, in which a master diaphragm is subjected to pressure by an actuation element;

FIG. 6 shows diagrammatically a side view of the microhydraulic system according to FIG. 5, in which the master diaphragm is subjected to tension by the actuation element;

FIG. 7 shows diagrammatically a side view of a microhydraulic system according to a fifth exemplary embodiment of the present disclosure, in which a master diaphragm is coupled to an actuation means via an actuation element having a lever portion, in an initial position;

FIG. 8 shows diagrammatically a side view of the microhydraulic system according to FIG. 7, in which the master diaphragm is subjected to pressure by the actuation element; and

FIG. 9 shows diagrammatically a side view of the microhydraulic system according to FIG. 7, in which the master diaphragm is subjected to tension by the actuation element.

In the figures, the same reference symbols designate identical or functionally identical elements, unless specified to the contrary.

### DETAILED DESCRIPTION

Since valves and pumping chambers differ from one another basically only in an additional web in the chamber of the hydraulically acting element (and, as a rule, also in the volume of the associated chamber), only pumping chambers are considered below, for simplification, in so far as the corresponding valve can be constructed in a technically similar way. The present disclosure can therefore apply, in general, to valves and pumping chambers.

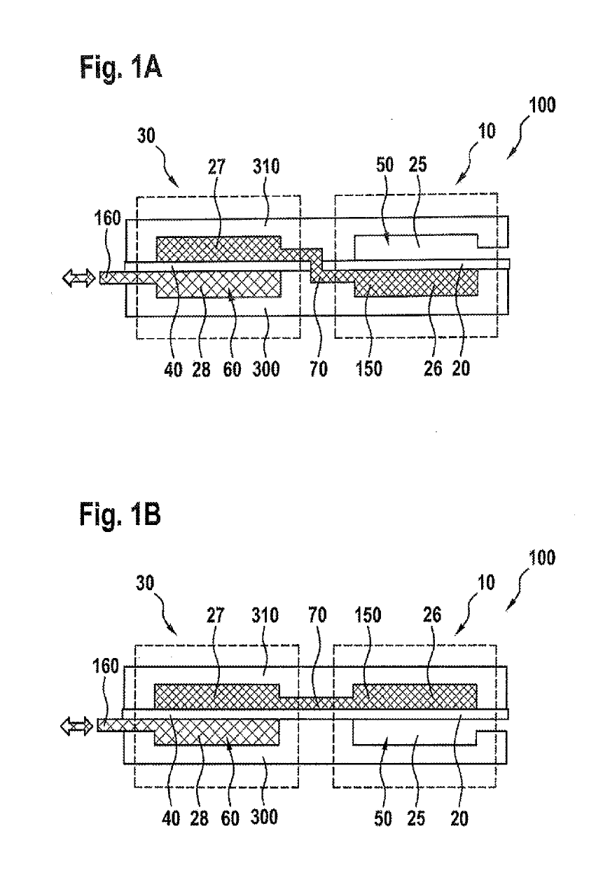

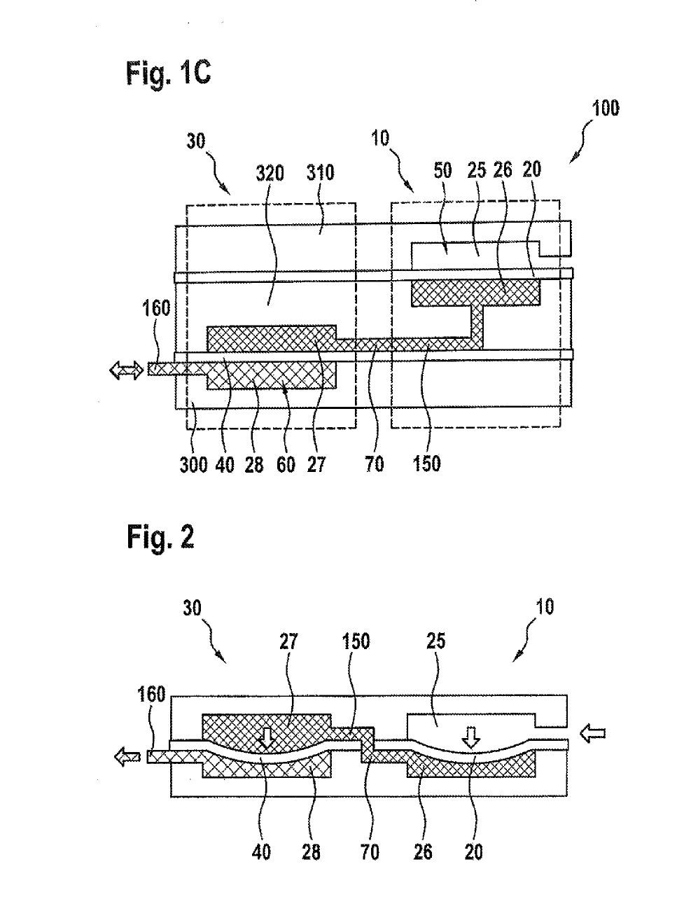

FIGS. 1A-1C show diagrammatically in each case a side view of a microhydraulic system 100 according to a first to a third exemplary embodiment of the present disclosure. The following statements apply, in general, to the first to the third exemplary embodiment. Deviations from the generally valid form of construction of the microhydraulic system 100 will be explained with reference to the respective exemplary embodiment.

The microhydraulic system 100 is preferably integrated into a (planar) microfluidic laboratory (not illustrated) which preferably has a layered construction in the context of a layer system, in particular as a polymer layer system. The microhydraulic system 100 is formed here in an upper polymer layer 300 and a lower polymer layer 310. In the third exemplary embodiment according to FIG. 1C, additionally a middle polymer layer 320 is also provided intermediately between the lower polymer layer 310 and the upper polymer layer 300.

The microhydraulic system 100 has a first hydraulically acting element 10 as the master element with a master diaphragm 20 and a second hydraulically acting element 30 as an actuator element with an actuator diaphragm 40, the master element being coupled fluidically to the actuator element via a fluid 150, and actuation of the master element implementing actuation of the actuator element. Both the master diaphragm 20 and the actuator diaphragm 40 are in this case in a neutral initial position, that is to say they are deformed neither elastically nor plastically. In the second half chamber 28 of the actuator chamber 60 there is a second fluid 160 which transmits the actuation of the actuator element in a direction of an outlet side of the microhydraulic system 100, as a result of which, in turn, further hydraulically acting elements (not illustrated) can be actuated.

The microhydraulic system 100 is characterized by a master chamber 50 and an actuator chamber 60. Each of the chambers 50, 60 is divided in each case into two half chambers (25, 26 and 27, 28) by the associated deformable diaphragm 20, 40. At least one fluidic flow duct 70 is formed in each case between one of the half chambers of the master chamber and the actuator chamber 50, 60. The fluidic flow duct 70 and also the master chamber and actuator chamber 50, 60 are filled, bubble-free, with the fluid 150 (especially preferably a hydraulic liquid). The special arrangement of the half chambers 25-28 in the present microhydraulic system 100 may vary as a function of the respective exemplary embodiment, although this does not change their basic function in any way.

Thus in the first exemplary embodiment and in the second exemplary embodiment, the master diaphragm 20 and the actuator diaphragm 40 are arranged essentially in one plane. In the third exemplary embodiment, the master diaphragm 20 and actuator diaphragm 40 are arranged in different planes of the polymer layer system. In the first exemplary embodiment, the fluid 150-filled half chamber 26 of the master chamber 50 is arranged with respect to the master diaphragm 20 on an opposite side of the fluid 150-filled half chamber 27 of the actuator chamber 60. In the second exemplary embodiment, the fluid 150-filled half chamber 26 of the master chamber 50 and the fluid 150-filled half chamber 27 of the actuator chamber 60 are arranged on the same side with respect to the master diaphragm 20. In the third exemplary embodiment, the master chamber 50 and the actuator chamber 60 are arranged in different planes. Moreover, the master diaphragm 20 and the actuator diaphragm 40 are also arranged in different planes. The master chamber 50 is formed partially in the upper polymer layer 300 and partially in the middle polymer layer 320. The actuator chamber 60 is formed partially in the middle polymer layer 320 and partially in the lower polymer layer 310.

FIG. 2 shows a side view of the microhydraulic system 100 according to the first exemplary embodiment of FIG. 1A of the present disclosure, in which the master diaphragm 20 is acted upon by a pressure. The master element is thus actuated pneumatically, compressed air being introduced into the first half chamber 25 of the master element. This ensures deformation of the master diaphragm 20 in that the latter is subjected to pressure and is deformed in the direction toward the second half chamber 26 of the master element. The deformation of the master diaphragm 20 in the second half chamber 26 of the master element leads to a displacement of the fluid 150 in the second half chamber 26, said fluid being moved in the direction of the fluidic flow duct 70 which is coupled fluidically to the first half chamber 27 of the actuator element. The first half chamber 27 of the actuator element receives the quantity of fluid 150 displaced out of the master element and at the same time the actuator diaphragm 40 is deformed in the direction toward the second half chamber 28 of the actuator element, with the result that the second fluid 160 is displaced out of the second half chamber 28. Thus, in the present microhydraulic system 100, subjecting the master element to a compressive force ensures that a compressive force is dispensed at the actuator element.

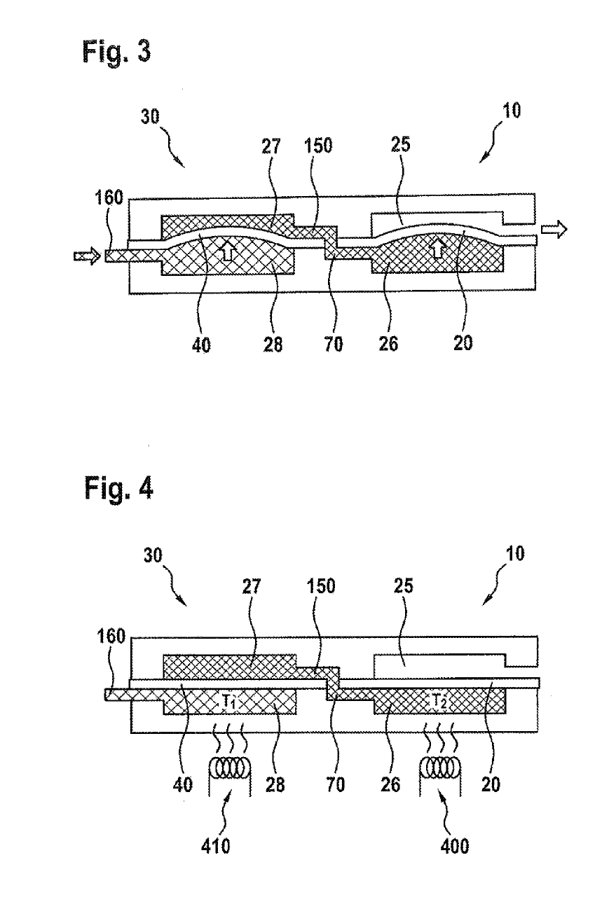

FIG. 3 shows a side view of the microhydraulic system 100 according to the first exemplary embodiment of FIG. 1A of the present disclosure, in which the master diaphragm 20 is subjected to a vacuum. The master element is again actuated pneumatically, air being discharged from the first half chamber 25 of the master element. This ensures deformation of the master diaphragm 20 in that the latter is subjected to tension and is deformed in the direction toward the first half chamber 25 of the master element. The deformation of the master diaphragm 20 toward the first half chamber 25 of the master element ensures that the fluid 150 is sucked in from the first half chamber 27 of the actuator element via the fluidic flow duct 70. In this case, the actuator diaphragm 40 is deformed in the direction toward the first half chamber 27 of the actuator element, with the result that the second fluid 160 is sucked into the second half chamber 28. Thus, in the present microhydraulic system 100, subjecting the master element to a vacuum ensures an outlet-side tensile force at the actuator element.

FIG. 4 shows a side view of the microhydraulic system 100 according to the first exemplary embodiment of FIG. 1A of the present disclosure, in which thermal harmonization between the two fluids 150, 160 separated from one another takes place. In order to stabilize thermally temperature-sensitive processes in the second half chamber 28 of the actuator element, the fluid 150 can be brought to the same temperature as the second fluid 160 in the second half chamber 28 of the actuator element. For this purpose, the fluid 150 is brought via a first heating element 400 from a temperature T2 to a temperature T1 which corresponds to the temperature of the second fluid 160. The temperature T2 in this case depends primarily on the nature and composition of the substances to be processed, but is preferably in a range of 50° C. to 95° C. The temperature T1 in this case is equated correspondingly over time to a temperature from the abovementioned temperature range. In addition to this, the second fluid 160 can likewise be heated via a second heating element 410 or, if appropriate, cooled. Thus, in spite of the insufficient thermal insulation of the actuator diaphragm 40, no thermal fluctuations arise in the second half chamber 28 of the actuator element when the fluid 150 is introduced into or discharged from the actuator element.

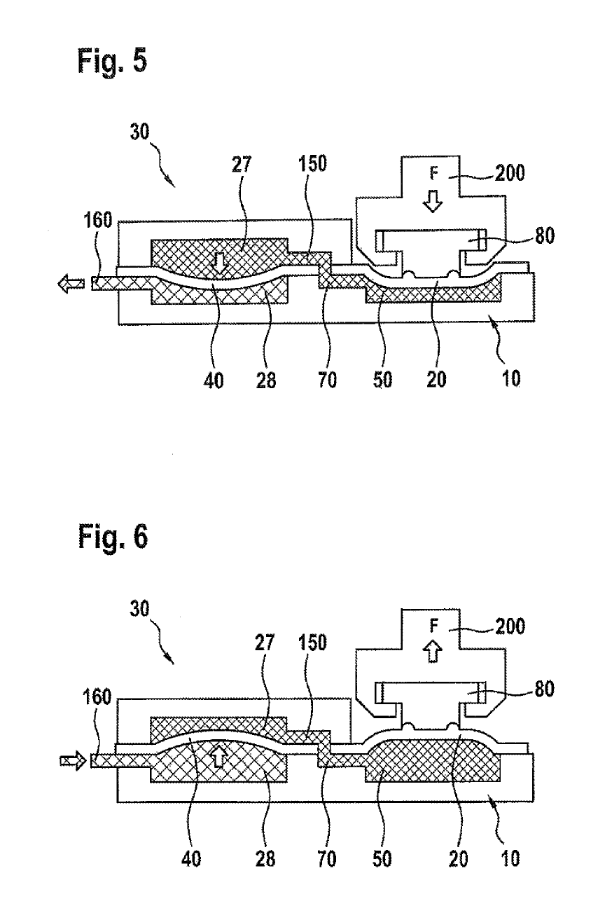

FIG. 5 shows diagrammatically a side view of a microhydraulic system 100 according to a fourth exemplary embodiment of the present disclosure, in which a master diaphragm 20 is subjected to pressure by an actuation element 80, and FIG. 6 shows diagrammatically a side view of the microhydraulic system 100 according to FIG. 5, in which the master diaphragm 20 is subjected to tension by the actuation element 80.

The master element 10 has a master chamber 50 which is coupled fluidically to a first half chamber 27 of an actuator element 30. The master element 10 has a master diaphragm 20 which is coupled to an actuation element 80 on the side lying opposite the master chamber 50. The actuator element 30 is coupled fluidically on the outlet side to a second fluid 160.

The actuation element 80 and the master diaphragm 20 are welded to one another, so that, depending on the actual direction of action of the actuation element 80, the master diaphragm 20 is subjected either to pressure or to tension and a fluid 150, which couples the master element fluidically to the actuator element, can thereby be acted upon correspondingly. The actuation element 80 is connected, in turn, positively to an actuation means 200, in particular as a component of a mechanical drive which thus generates a direct mechanical action of the analyzer (not illustrated) upon the master diaphragm 20. The mechanical drive may be implemented by electric drives (not illustrated), such as, for example, electric motors (in conjunction with a threaded rod or with an eccentric in order to convert the rotational movement of the electric motor into a linear movement), piezoelectric actuators, electrostatic actuators or electromagnetic actuating drives (for example, moving-coil drives). Since, in these electric drives, the generation in time of the mechanical force upon the master diaphragm 20 can be controlled in a simple way, it is thereby also possible to operate each master element with an individual pressure or tension or with an individual pressure or tension profile curve by means of an electronic control. By the analyzer being programmed correspondingly, the actuating behavior can be adapted freely to the requirements of the analysis application which is implemented on a specific cartridge (not illustrated).

Although the actuation of the master element in the fourth exemplary embodiment of the present disclosure takes place differently from that in the first exemplary embodiment of the present disclosure, the action of the master element and of the actuator element is similar to this. Reference is therefore made to the corresponding statements relating to FIGS. 3 and 4 which are to be adapted appropriately to the present elements of the fourth exemplary embodiment of the present disclosure.

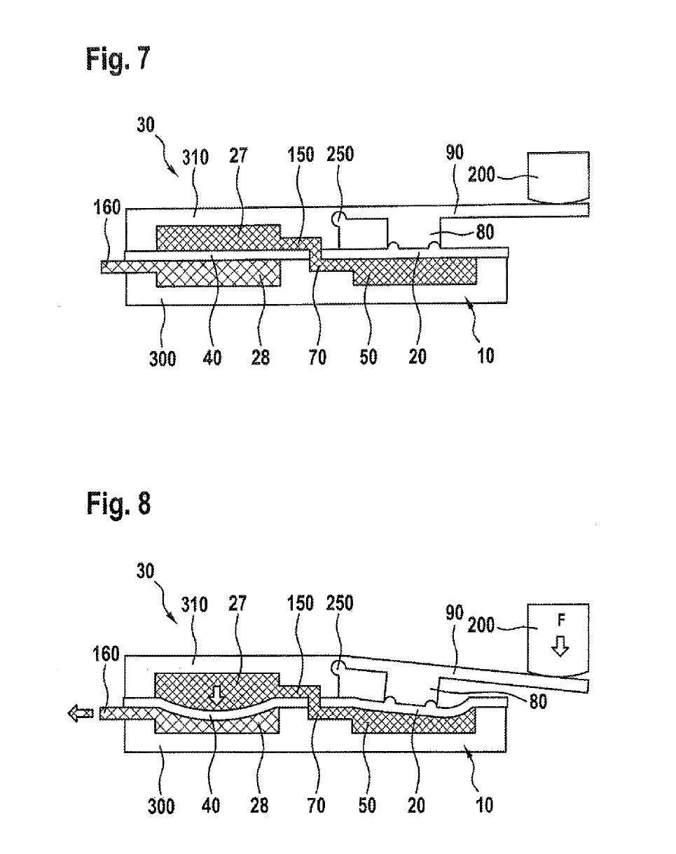

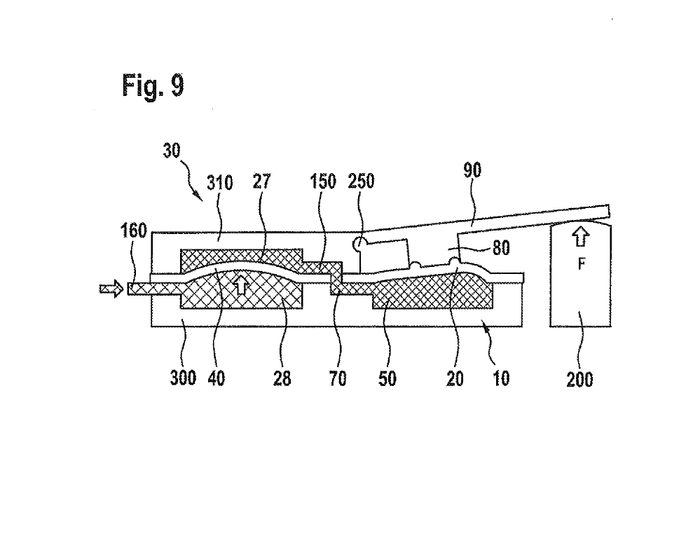

FIG. 7 shows diagrammatically a side view of a microhydraulic system 100 according to a fifth exemplary embodiment of the present disclosure, in which a master diaphragm 20 is coupled to an actuation means 200 via an actuation element 80 having a lever portion 90, in an initial position. FIG. 8 shows diagrammatically a side view of the microhydraulic system 100 according to FIG. 7, in which the master diaphragm 20 is subjected to pressure by the actuation element 80; and FIG. 9 shows diagrammatically a side view of the microhydraulic system 100 according to FIG. 7, in which the master diaphragm 20 is subjected to tension by the actuation element 80.

The microhydraulic system 100 has a first hydraulically acting element 10 as a master element with a master diaphragm 20 and a second hydraulically acting element 30 as an actuator element with an actuator diaphragm 40, the master element being coupled fluidically to the actuator element via a fluid 150, and actuation of the master element implementing actuation of the actuator element. According to FIG. 7, both the master diaphragm 20 and the actuator diaphragm 40 are in a neutral initial position, that is to say they are deformed neither elastically nor plastically. In the second half chamber 28 of the actuator chamber 60 there is a second fluid 160 which transmits the actuation of the actuator element in the direction of an outlet side of the microhydraulic system 100, as a result of which, in turn, further hydraulically acting elements (not illustrated) can be actuated.

The microhydraulic system 100 is likewise preferably integrated into a (planar) microfluidic laboratory (not illustrated) which preferably has a layered construction in the context of a layer system, in particular as a polymer layer system. The microhydraulic system 100 is formed in an upper polymer layer 300 and a lower polymer layer 310.

The master element is coupled to an actuation element 80 on the side lying opposite the master chamber 50. The actuation element 80 and the master diaphragm 20 are welded to one another, so that, depending on the actual direction of action of the actuation element 80, the master diaphragm 20 is subjected either to pressure or to tension, and the fluid 150 can thereby be acted upon correspondingly. The actuation element 80 has a lever portion 90 which extends away from the master chamber 50 in the lateral direction over a predetermined length. As a function of the selected length of the lever portion 90, a force introduced into the actuation element 80 by the actuation means 200 can be multiplied within the microhydraulic system 100.

The actuation element 80 is connected via the lever portion 90 to the actuation means 200, which, particularly as a component of a mechanical drive, thereby generates a direct mechanical action of the analyzer (not illustrated) upon the master diaphragm 20. The mechanical drive may again be implemented by electric drives, such as have already been described above with reference to FIGS. 5 and 6. The actuation element 80 is connected on the side lying opposite the lever portion 90 to a joint element 250 which is partially formed in the upper polymer layer 300. The joint element 250 serves preferably for guiding the actuation element 80 during the operation of the microhydraulic system 100.

Referring to FIGS. 8 and 9, in the present microhydraulic system 100, in a similar way to the exemplary embodiments described above, actuation of the master element ensures actuation of the actuator element and, more specifically, subjecting the master element to tensile force or compressive force leads to (outlet-side) tensile force or compressive force at the actuator element.

Although the disclosure has been described in the present context by means of preferred exemplary embodiments, it is in no way restricted to these, but can be modified in many different ways. In particular, it is pointed out that, in the present context, “one” does not rule out a multiplicity.

What is claimed is:

1. A microhydraulic system comprising:
a first hydraulically acting element that defines a master element having a master diaphragm; and
a second hydraulically acing element that defines an actuator element having an actuator diaphragm;
wherein the master diaphragm is coupled fluidically to the actuator diaphragm such that deflection of the master diaphragm causes deflection of the actuator diaphragm, and actuation of the master diaphragm via provision of a compressive force and a tensile force:
wherein the master diaphragm is configured to exert a compressive or tensile force upon the actuator diaphragm as a function of deflection of the master diaphragm.

2. The microhydraulic system according to claim 1, wherein:
the master element further has a master chamber;
the actuator element further has an actuator chamber that is different than the master chamber; and
the master chamber is coupled to the actuator chamber via a fluidic flow duct.

3. The microhydraulic system according to claim 2, wherein:
the master diaphragm and the actuator diaphragm are positioned substantially in one plane; and
a fluid-filled half chamber of the master chamber is located, with respect to the master diaphragm, on an opposite side of a fluid-filled half chamber of the actuator chamber.

4. The microhydraulic system according to claim 2, wherein:
the master diaphragm and the actuator diaphragm are positioned substantially in one plane; and
a fluid-filled half chamber of the master chamber is located, with respect to the master diaphragm, on a same side as a fluid-filled half chamber of the actuator chamber.

5. The microhydraulic system according to claim 2, wherein the master diaphragm and the actuator diaphragm are positioned in different planes.

6. The microhydraulic system according to claim 1, wherein:
one of the master element or the actuator element has a master chamber or an actuator chamber respectively; and
the master diaphragm or actuator diaphragm is coupled directly via a fluidic flow duct to the actuator chamber or master chamber respectively.

7. The microhydraulic system according to claim 1, wherein the master diaphragm is coupled to an actuation element.

8. The microhydraulic system according to claim 7, wherein the actuation element is coupled to the master diaphragm such that the actuation element, as a function of a direction of action of the actuation element, is configured to exert a compressive or tensile force upon the master diaphragm.

9. The microhydraulic system according to claim 7, wherein the actuation element is coupled magnetically to the master diaphragm.

10. The microhydraulic system according to claim 7, wherein the actuation element has a lever portion configured to cooperate with an actuation member to actuate the master element.

11. The microhydraulic system according to claim 1, wherein at least one of the master diaphragm and the actuator diaphragm is impermeable to a fluid.

12. The microhydraulic system according to claim 1, wherein a freezing point and a boiling point of a fluid for the microhydraulic system are selected such that the fluid is in a liquid state over an entirety of a temperature range which occurs at the actuator diaphragm during operation.

13. The microhydraulic system according to claim 1, wherein a temperature of a fluid for the microhydraulic system during operation is substantially identical to a temperature of a second fluid which is coupled to the actuator diaphragm on an outlet side of the actuator element.

14. The microhydraulic system according to claim 2, wherein a flow resistance in the fluidic flow duct varies depending on at least one of a length and a diameter of the fluidic flow duct.

15. The microhydraulic system according to claim 6, wherein a flow resistance in the fluidic flow duct varies depending on at least one of a length and a diameter of the fluidic flow duct.
